(19) United States
(12) Patent Application Publication
(10) Pub. No.: US 2011/0132999 A1
(43) Pub. Date: Jun. 9, 2011

(54) HOUSING AND ELECTRONIC DEVICE USING THE SAME

(75) Inventors: KUN-TSAN WU, Shindian (TW); CHIH-WEI LIAO, Shindian (TW)

(73) Assignee: FIH (HONG KONG) LIMITED, Kowloon (HK)

(21) Appl. No.: 12/753,100

(22) Filed: Apr. 2, 2010

(30) Foreign Application Priority Data
Dec. 4, 2009 (CN) 200910310937.8

(51) Int. Cl. B05B 15/00

(52) U.S. Cl. 239/289

(57) ABSTRACT

A housing is used in an electronic device. The housing includes a storing chamber, a diffusion chamber, a ventilating element; and a plurality of air holes defined in the diffusion chamber. The storing chamber is configured for receiving perfume. The diffusion chamber communicates with the storing chamber by a slit. The ventilating element seals the slit to prevent liquid flow therethrough. The diffusion chamber comprises a channel, the smell of the perfume penetrates the ventilating element from the storing chamber to the channel and exit the housing though the air holes. The present disclosure further discloses an electronic device using the housing.

### BACKGROUND

1. Technical Field

The present disclosure generally relates to housings, and particularly to a housing used in electronic devices.

2. Description of Related Art

Mobile phones, e.g., a cellular phone, is typically small and lightweight which may be easily carried or stored in a bag or pocket. The mobile phone may incorporate a perfume spraying apparatus for extra appeal. However, the typical perfume spraying apparatus cannot accurately control an amount of sprayed perfume without an opening/closing valve, and the perfume may stain the mobile phone or the user's clothes. Also, if the perfume spraying apparatus includes an opening/closing valve, it may require a large and complicated mechanism for spraying perfume. Thus, it may be difficult to include a perfume spraying apparatus in a small and lightweight mobile phone.

Therefore, there is a room for improvement within the art.

### BRIEF DESCRIPTION OF THE DRAWINGS

Many aspects of a housing and electronic device using the same can be better understood with reference to the following drawings. The components in the drawings are not necessarily to scale, the emphasis instead being placed upon clearly illustrating the housing and electronic device using the same. Moreover, in the drawings, like reference numerals designate corresponding parts throughout the several views.

FIG. 1 is an assembled, isometric view of an exemplary electronic device.

FIG. 2 is an exploded, isometric view of an exemplary housing.

FIG. 3 is an exploded, isometric view of an exemplary housing shown in FIG. 2, but from another angle.

FIG. 4 is an assembled, isometric view of the housing shown in FIG. 3.

FIG. 5 is an isometric view of an upper housing shown in FIG. 4.

FIG. 6 is a cut-away view of the upper housing shown in FIG. 5.

### DETAILED DESCRIPTION

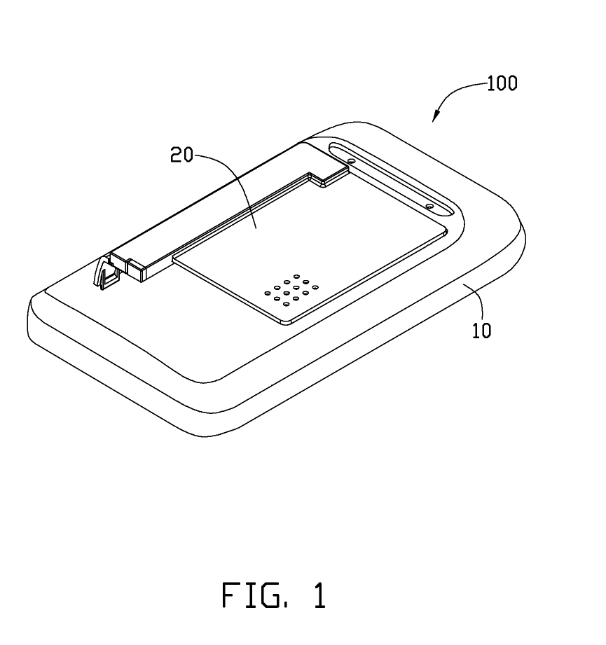

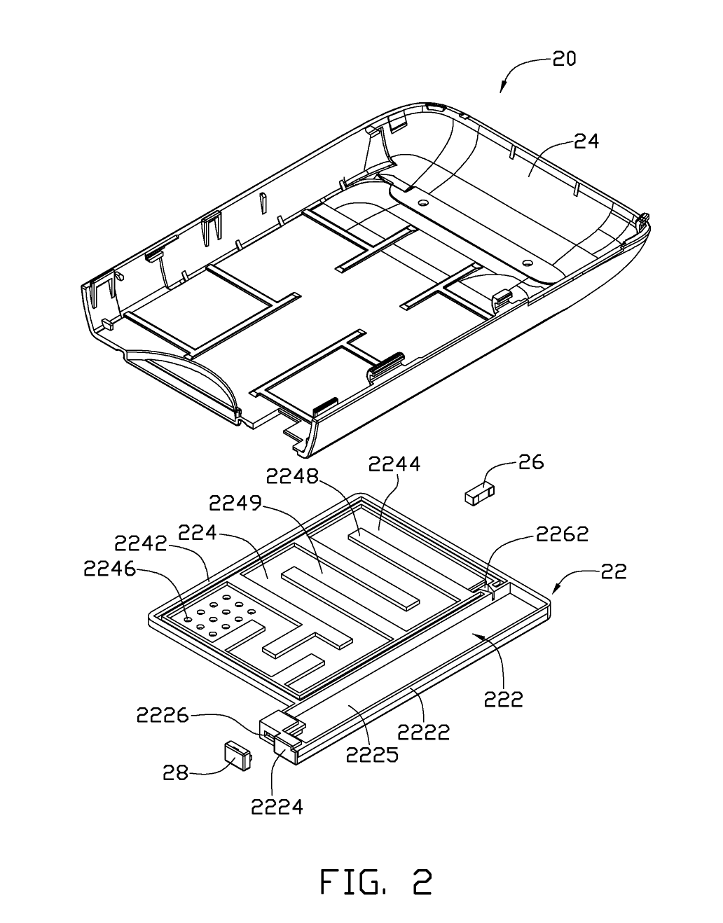

FIG. 1 and FIG. 2 show an exemplary embodiment of an electronic device 100, such as mobile phone, personal digital assistant, and so on. The electronic device 100 includes a main body 10 and a housing 20 covering the main body 10.

The housing 20 includes an upper housing 22, a lower housing 24 matching with the upper housing 22, a ventilating element 26, and a plug 28. The upper housing 22 defines a storing slot 222 and a diffusion slot 224 communicating with the storing slot 222 by a slit 2262. The storing slot 222 is configured for storing perfume or balsam, etc. In the exemplary embodiment, the perfume is stored in the storing slot 222. The perfume smell can flow into the diffusion slot 224 through the slit 2262.

Two opposite sidewalls 2222, two opposite end walls 2224, and a first bottom wall 2225 cooperatively surround the storing slot 222. One of the end walls 2224 defines a through hole 2226. The perfume can be filled in the storing slot 222 through the through hole 2226.

Four peripheral walls 2242 and a second bottom wall 2244 cooperatively define the diffusion slot 224. The second bottom wall 2244 defines a plurality of air holes 2246 at a corner thereof. A plurality of spaced sheets 2248 uniformly extend from two opposite peripheral walls 2242, and are disposed on the second bottom wall 2244. Thus, a channel 2249 is defined among the sheets 2248. The channel 2249 communicates with the air holes 2246 and the slit 2262. The slit 2262 is v-shaped defined in one peripheral walls 2242 overlapped one sidewall 2222. The channel 2249 is configured to avoid the perfume from directly contacting the air out of the housing 20.

The ventilating element 26 can be made of a breathable material. The breathable material does not allow liquid flow therethough but does allow gas/vapor flow therethrough. The ventilating element 26 seals the slit 2262 from liquid flow therethrough. Thus, it is not possible for the liquid perfume to flow into the diffusion slot 224, but the smell (gas/vapor) of the perfume can penetrate the ventilating element 26. The plug 28 can seal the through hole 2226 to avoid the perfume flowing away from the storing slot 222.

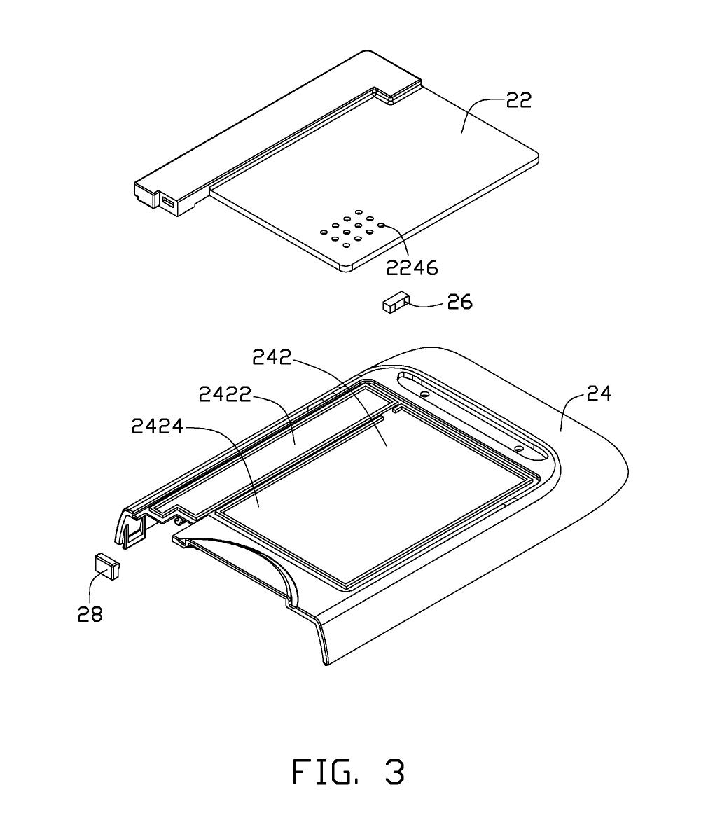

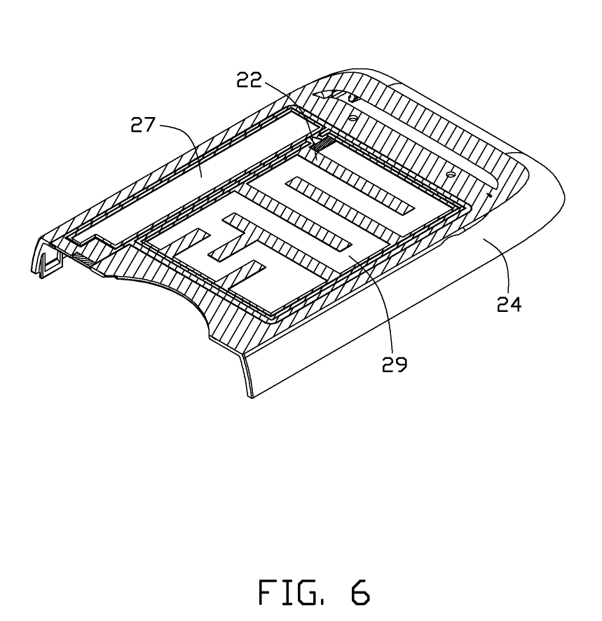

Referring to FIG. 3 and FIG. 6, the lower housing 24 defines a receiving chamber 242 including a first sealing portion 2422 and a second sealing portion 2424. In the exemplary embodiment, the first sealing portion 2422 and the second sealing portion 2424 are a bottom of the receiving chamber 242. The first sealing portion 2422 is configured for sealing the storing slot 222 to form a storing chamber 27. The second sealing portion 2424 is configured for sealing the diffusion slot 224 to form a diffusion chamber 29.

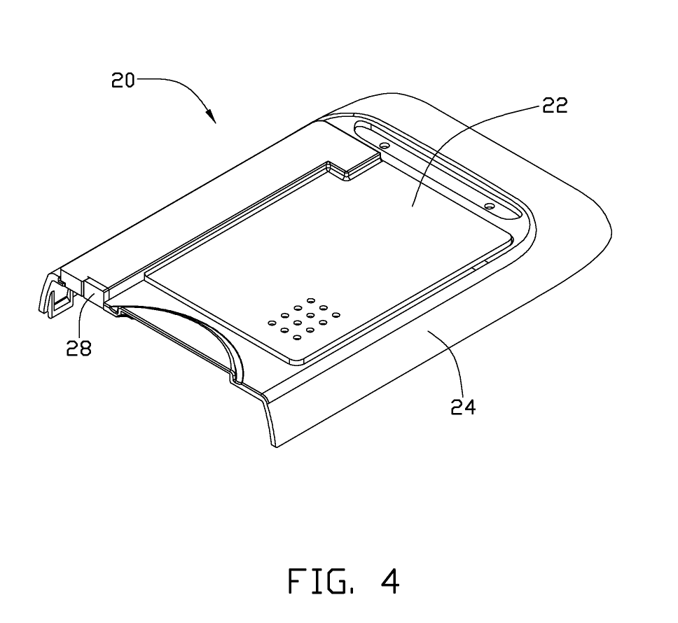

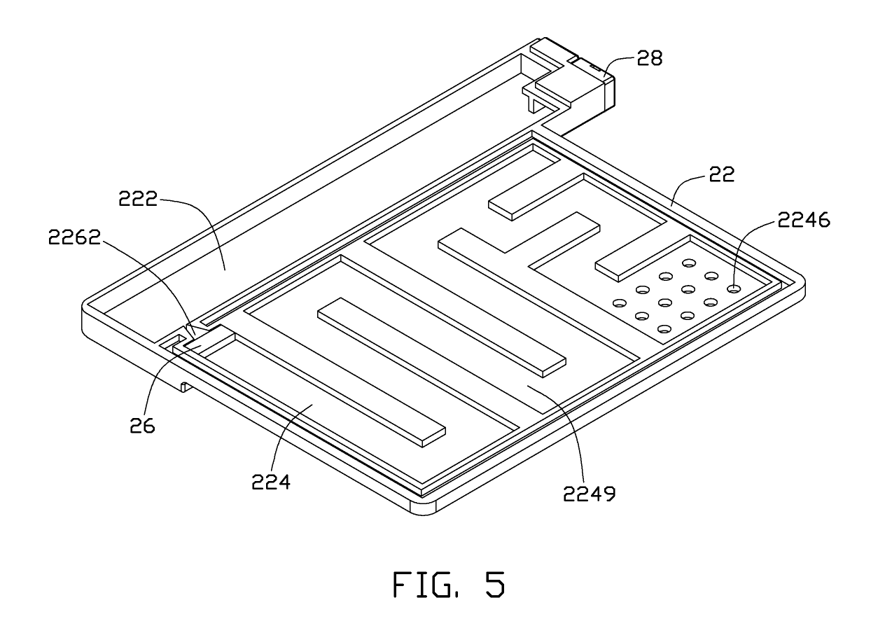

Referring to FIG. 4 and FIG. 5, in assembly, the ventilating element 26 is attached to the second bottom wall 2244 adjacent to the slit 2262 by a viscous glue. Thus, the ventilating element 26 seals the slit 2262. Then, the lower housing 24 covers the upper housing 22. The first sealing portion 2422 and the second sealing portion 2424 seal the storing slot 222 to form a storing chamber 27. Finally, the perfume is filled in the storing chamber 27, and the plug 28 seals the through hole 2226. Thus, the housing 20 is completely assembled.

The liquid perfume cannot flow into the diffusion chamber 29 because the ventilating element 26 seals the slit 2262 from liquid flow therethrough. However, the smell of the perfume can penetrate the ventilating element 26 to the diffusion chamber 29. The smell of the perfume can gather in the channel 2249 and exit the housing 20 though the air holes 2246.

The housing 20 has a simple structure and doesn't need a device to spray the perfume out of the electronic device 100, which allows for decreasing the size of the electronic device 100. Moreover, the liquid perfume can not be sprayed out of the housing 20 and the liquid perfume may not stain the electronic device 100 or the user's clothes.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing for an electronic device, the housing comprising:
a storing chamber for receiving perfume;
a diffusion chamber communicating with the storing chamber by a slit,
a ventilating element sealing the slit to prevent liquid flow therethrough; and
a plurality of air holes defined in the diffusion chamber;
wherein the diffusion chamber comprises a plurality of sheets to form a channel, the channel communicates with the air holes and the slit.

2. The housing as claimed in claim 1, wherein the housing comprises an upper housing and a lower housing matching with the upper housing, the upper housing defines a storing slot and a diffusion slot communicating with the storing slot by the slit.

3. The housing as claimed in claim 2, wherein the lower housing comprises a first sealing portion and a second sealing portion; the first sealing portion seals the storing slot to form the storing chamber, the second sealing portion seals the diffusion slot to form the diffusion chamber.

4. The housing as claimed in claim 1, wherein four peripheral walls and a second bottom wall cooperatively define the diffusion slot; the sheets uniformly spaced extend from two opposite peripheral walls, and are disposed on the second bottom wall.

5. The housing as claimed in claim 4, wherein the ventilating element is attached to the second bottom wall adjacent to the slit by viscous glue.

6. The housing as claimed in claim 4, wherein the ventilating element is made of a breathable material.

7. The housing as claimed in claim 1, wherein the storing chamber defines a through hole; the housing further comprises a plug detachably assembled in the through hole.

8. A housing for an electronic device, the housing comprising:
a storing chamber for receiving perfume;
a diffusion chamber communicating with the storing chamber by a slit,
a ventilating element sealing the slit to prevent liquid flow therethrough; and
a plurality of air holes defined in the diffusion chamber;
wherein the diffusion chamber comprises a channel, the smell of the perfume penetrates the ventilating element from the storing chamber to the channel and exit the housing though the air holes.

9. The housing as claimed in claim 8, wherein the housing comprises an upper housing and a lower housing matching with the upper housing, the upper housing defines a storing slot and a diffusion slot communicating with the storing slot by the slit.

10. The housing as claimed in claim 9, wherein the lower housing comprises a first sealing portion and a second sealing portion; the first sealing portion seals the storing slot to form the storing chamber, the second sealing portion seals the diffusion slot to form the diffusion chamber.

11. The housing as claimed in claim 8, wherein four peripheral walls and a second bottom wall cooperatively define the diffusion slot; the sheets uniformly spaced extend from two opposite peripheral walls, and are disposed on the second bottom wall.

12. The housing as claimed in claim 11, wherein the ventilating element is attached to the second bottom wall adjacent to the slit by a viscous glue.

13. The housing as claimed in claim 8, wherein the storing chamber defines a through hole; the housing further comprises a plug detachably assembled in the through hole.

14. An electronic device, comprising:
a main body;
a housing covering the main body, the housing comprising:
a storing chamber for receiving perfume;
a diffusion chamber communicating with the storing chamber by a slit,
a ventilating element sealing the slit to prevent liquid flow therethrough; and
a plurality of air holes defined in the diffusion chamber;
wherein the diffusion chamber comprises a plurality of sheets spaced extend from two opposite peripheral walls to form a channel, the channel communicates with the air holes and the slit.

15. The electronic device as claimed in claim 14, wherein the housing comprises an upper housing and a lower housing matching with the upper housing, the upper housing defines a storing slot and a diffusion slot communicating with the storing slot by the slit.

16. The electronic device as claimed in claim 15, wherein the lower housing comprises a first sealing portion and a second sealing portion; the first sealing portion seals the storing slot to form the storing chamber, the second sealing portion seals the diffusion slot to form the diffusion chamber.

17. The electronic device as claimed in claim 14, wherein the four peripheral walls and a second bottom wall cooperatively define the diffusion slot; the sheets uniformly spaced extend from two opposite peripheral walls, and are disposed on the second bottom wall.

18. The electronic device as claimed in claim 17, wherein the ventilating element is attached to the second bottom wall adjacent to the slit by a viscous glue.

19. The electronic device as claimed in claim 17, wherein the ventilating element is made of a breathable material.
